(19) United States
(12) Patent Application Publication
(10) Pub. No.: US 2014/0102093 A1
(43) Pub. Date: Apr. 17, 2014

(54) MULTISTAGE TURBOCHARGING SYSTEM

(71) Applicants: Tomohiro HONMA, Tokyo (JP); Kenji BUNNO, Tokyo (JP); Fumihiko FUKUHARA, Tokyo (JP)

(72) Inventors: Tomohiro HONMA, Tokyo (JP); Kenji BUNNO, Tokyo (JP); Fumihiko FUKUHARA, Tokyo (JP)

(21) Appl. No.: 14/132,498

(22) Filed: Dec. 18, 2013

Related U.S. Application Data
(63) Continuation of application No. PCT/JP2012/066026, filed on Jun. 22, 2012.

(30) Foreign Application Priority Data
Jun. 22, 2011 (JP) 2011-138309

(51) Int. Cl. F02B 37/013; F02B 37/18

(52) U.S. Cl. CPC F02B 37/013; F02B 37/183
USPC 60/602; 60/707

(57) ABSTRACT

A multistage turbocharging system provided with a first turbocharger, a second turbocharger, and an exhaust bypass valve device, in which a seal surface of the opening of the bypass flow passage that is abutted by the bottom surface of the valve body of the exhaust bypass valve device has a higher oxidation resistance than the housing of the second turbocharger.

This application is a Continuation of International Application No. PCT/JP2012/066026, filed on Jun. 22, 2012, claiming priority based on Japanese Patent Application No. 2011-138309, filed Jun. 22, 2011, the content of which is incorporated herein by reference in their entity.

### TECHNICAL FIELD

The present invention relates to a multistage turbocharging system.

### BACKGROUND ART

There has previously been proposed a two-stage turbocharging system (multistage turbocharging system) that is provided with two (multiple) turbochargers. This kind of two-stage turbocharging system, by being provided with two turbochargers of differing capacities, efficiently generates compressed air by changing the state of exhaust gas being supplied to the two turbochargers in accordance with the flow amount of exhaust gas supplied from an internal combustion engine.

In greater detail, the two-stage turbocharging system is for example provided with a low-pressure stage turbocharger that is supplied with exhaust gas that is discharged from the internal combustion engine (first turbocharger), a high-pressure stage turbocharger that is arranged further on the upstream than this low-pressure stage turbocharger (second turbocharger), and an exhaust bypass valve device that performs opening and closing of a bypass flow passage that supplies the exhaust gas that is discharged from the internal combustion engine to the low-pressure stage turbocharger by bypassing the turbine impeller of the high-pressure stage turbocharger.

As this kind of exhaust bypass valve device, it is possible to use the exhaust bypass valve device that is disclosed, for example, in Patent Document 2.

In the exhaust bypass valve device, in the case of closing the bypass flow passage by the exhaust bypass valve device, exhaust gas is supplied to the high-pressure stage turbocharger, and in the case of opening the bypass flow passage by the exhaust bypass valve device, exhaust gas is supplied to the low-pressure stage turbocharger.

### PRIOR ART DOCUMENTS

### Patent Documents

[Patent Document 1] Japanese Unexamined Patent Application, First Publication No. 2009-92026
[Patent Document 2] Published Japanese Translation No. 2002-508473 of the PCT International Publication

### DISCLOSURE OF THE INVENTION

### Problems to be Solved by the Invention

The exhaust bypass valve device is provided with a valve body in which, when abutted with the opening end of the bypass flow passage, the bypass flow passage is closed, and when detached from the opening end of the bypass flow passage, the bypass flow passage is opened. Also, the flow passage wall of the bypass flow passage is formed by a portion of the housing of the turbocharger.

That is to say, the closing and opening of the bypass flow passage is stipulated by whether the bottom surface of the valve body is abutted with or detached from a portion of the housing of the turbocharger.

In this kind of two-stage turbocharging system, since exhaust gas flows within the housing, a portion of the housing that is formed with cast iron is oxidized over the long term. On the other hand, since a large quantity of exhaust gas flows in the bypass flow passage that is formed by a portion of the housing, a large difference occurs in the temperature of the bypass flow passage between the case in which the exhaust gas is flowing, and the case in which the exhaust gas not flowing.

Here, when the opening end surface of the bypass flow passage is oxidized, a large difference arises in the thermal expansion coefficient between the region that is oxidized and the region that is not oxidized, and so over a long period of time a portion of the opening end surface (seal surface) of the bypass flow passage may exfoliate. Also, since the bottom surface of the valve body is repeatedly abutted with the seal surface of the bypass flow passage, exfoliation at the seal surface is sometimes promoted thereby.

When a portion of the seal surface of the bypass flow passage exfoliates due to this kind of thermal stress and mechanical stress, the seal performance when the valve body closes the bypass flow passage worsens, and so some of the exhaust gas leaks out from the bypass flow passage irrespective of whether the bypass flow passage is closed, leading to a drop in the performance of the two-stage turbocharging system.

The present invention was achieved in view of the aforementioned circumstances and has as its object to prevent exfoliation at the seal surface of the bypass flow passage in a multistage turbocharging system, and prevent leakage of exhaust gas from the bypass flow passage when closed.

### Means for Solving the Problems

The multistage turbocharging system according to the first aspect of the present invention is provided with a first turbocharger that is supplied with exhaust gas that is discharged from an internal combustion engine, a second turbocharger that is arranged more on the upstream in the flow of the exhaust gas than the first turbocharger, and an exhaust bypass valve device that performs opening and closing of a bypass flow passage that supplies the exhaust gas that is discharged from the internal combustion engine to the first turbocharger by bypassing the turbine impeller of the second turbocharger, in which a seal surface of the opening of the bypass flow passage that is abutted by the bottom surface of a valve body of the exhaust bypass valve device has a higher oxidation resistance than the housing of the second turbocharger.

In the multistage turbocharging system according to the second aspect of the present invention, the seal surface is formed by a ring member that is formed with austenitic stainless steel in the multistage turbocharging system according to the first aspect.

In the multistage turbocharging system according to the third aspect of the present invention, the ring member is fixed by being press-fitted into the housing of the second turbocharger, and has a retaining mechanism that restricts movement in the direction that is opposite to the direction of press-fitting the ring member with respect to the housing of the second turbocharger in the multistage turbocharging system according to the second aspect.

In the multistage turbocharging system according to the fourth aspect of the present invention, the seal surface is set to an annular shape having an outer diameter smaller than the outer diameter of the bottom surface of the valve body in the multistage turbocharging system according to the second aspect or the third aspect.

In the multistage turbocharging system according to the fifth aspect of the present invention, the retaining mechanism is a protruding portion that is one portion of the ring member that has been press-fitted into the housing of the second turbocharger, and that has been partially released from the elastic compression by the housing of the second turbocharger in the multistage turbocharging system according to the third aspect.

In the multistage turbocharging system according to the sixth aspect of the present invention, the retaining mechanism is a protruding portion that is one portion of the housing of the second turbocharger into which the ring member has been press-fitted, and that has been partially released from the elastic expansion by the ring member in the multistage turbocharging system according to the third aspect.

### Effects of the Invention

According to the present invention, the seal surface of the opening of the bypass flow passage has a higher oxidation resistance than the housing of the second turbocharger. For this reason, it is possible to suppress oxidation of a portion or the entirety of the seal surface of the opening of the bypass flow passage.

As a result, it is possible to prevent exfoliation at the seal surface without a large difference arising in the thermal expansion coefficient at the seal surface.

### BRIEF DESCRIPTION OF THE DRAWINGS

FIG. 1 is a schematic drawing that shows the outline configuration of an engine system provided with a multistage turbocharging system in one embodiment of the present invention.

FIG. 2A is an enlarged view that includes an exhaust bypass valve device that the multistage turbocharging system in one embodiment of the present invention is provided with.

FIG. 2B is an enlarged view that includes the exhaust bypass valve device that the multistage turbocharging system in one embodiment of the present invention is provided with.

FIG. 3 is a perspective view of a ring member that the multistage turbocharging system in one embodiment of the present invention is provided with.

FIG. 4A is a cross-sectional view that shows a modification of the multistage turbocharging system in one embodiment of the present invention, and includes the ring member.

FIG. 4B is a cross-sectional view that shows a modification of the multistage turbocharging system in one embodiment of the present invention, and includes the ring member.

FIG. 4C is a cross-sectional view that shows a modification of the multistage turbocharging system in one embodiment of the present invention, and includes the ring member.

FIG. 4D is a cross-sectional view that shows a modification of the multistage turbocharging system in one embodiment of the present invention, and includes the ring member.

### EMBODIMENTS FOR CARRYING OUT THE INVENTION

Hereinbelow, one embodiment of the multistage turbocharging system according to the present invention shall be described with reference to the drawings. Note that in the drawings given below, the scale of each member shall be suitably changed in order to make each member a recognizable size. Also, in the following description, as one example of a multistage turbocharging system, a two-stage turbocharging system that is provided with two turbochargers shall be described.

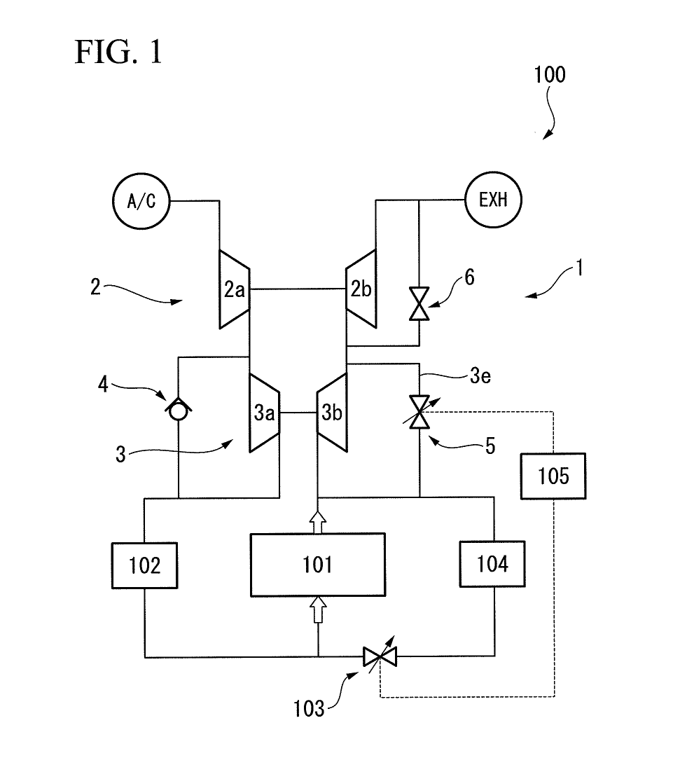

FIG. 1 is a schematic drawing that shows the outline constitution of an engine system 100 that is provided with a two-stage turbocharging system 1 of the present embodiment. The engine system 100 is one that is mounted in a vehicle or the like, and is provided with a two-stage turbocharging system 1, an engine 101 (internal-combustion engine), an intercooler 102, an EGR (exhaust gas recirculation) valve 103, an EGR cooler 104, and an ECU (engine control unit) 105.

The two-stage turbocharging system 1 recovers energy that is included in the exhaust gas that is discharged from the engine 101 as rotational force, and generates compressed air that is supplied to the engine 101 by this rotational force.

This two-stage turbocharging system 1 has the characteristic of the present invention, and so shall be described in detail referring to the drawings.

The engine 101 functions as a power source of a vehicle in which it is mounted, generates power by combusting an air-fuel mixture of compressed air that is supplied from the two-stage turbocharging system and fuel, and supplies the exhaust gas that is generated by the combustion of the air-fuel mixture to the two-stage turbocharging system 1.

The intercooler 102 cools the compressed air that is supplied from the two-stage turbocharging system 1 to the engine 101, and is arranged between the two-stage turbocharging system 1 and the intake port of the engine 101.

The EGR valve 103 performs opening and closing of a return flow passage that returns a portion of the exhaust gas discharged from the engine 101 to the air intake side of the engine 101, with the opening degree thereof being adjusted by the ECU 105.

The EGR cooler 104 cools the exhaust gas to be returned to the air intake side of the engine 101 via the return flow passage, and is arranged on the upstream of the EGR valve 103.

The ECU 105 controls the entire engine system 100.

The ECU 105 in the engine system 100 controls the aforementioned EGR valve 103 and a discharge bypass valve device 5 described below in accordance with the rotational frequency of the engine 101 (that is to say, the flow amount of exhaust gas).

In the engine system 100 that has this kind of constitution, when the exhaust gas that is produced by the combustion of the air-fuel mixture in the engine 101 is discharged, a portion of the exhaust gas is returned to the air intake side of the engine 101 via the EGR cooler 104, while most of the exhaust gas is supplied to the two-stage turbocharging system 1. Compressed air is generated in the two-stage turbocharging system 1, and this compressed air is supplied to the engine 101 after being cooled by the intercooloer 102.

Next, the two-stage turbocharging system 1 shall be described.

As shown in FIG. 1, the two-stage turbocharging system 1 is provided with a low-pressure stage turbocharger 2 (first turbocharger), a high-pressure stage turbocharger 3 (second turbocharger), a check valve 4, an exhaust bypass valve device 5, and a waste gate valve 6.

The low-pressure stage turbocharger 2 is arranged more to the downstream than the high-pressure stage turbocharger 3 in the flow direction of the exhaust gas, and is constituted to be larger than the high-pressure stage turbocharger 3. This low-pressure stage turbocharger 2 is provided with a low-pressure stage compressor 2a and a low-pressure stage turbine 2b.

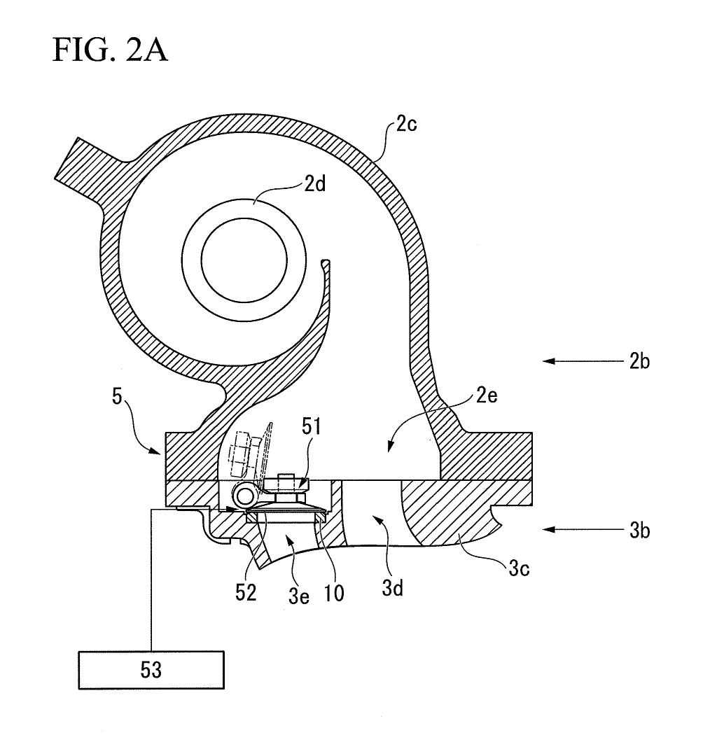

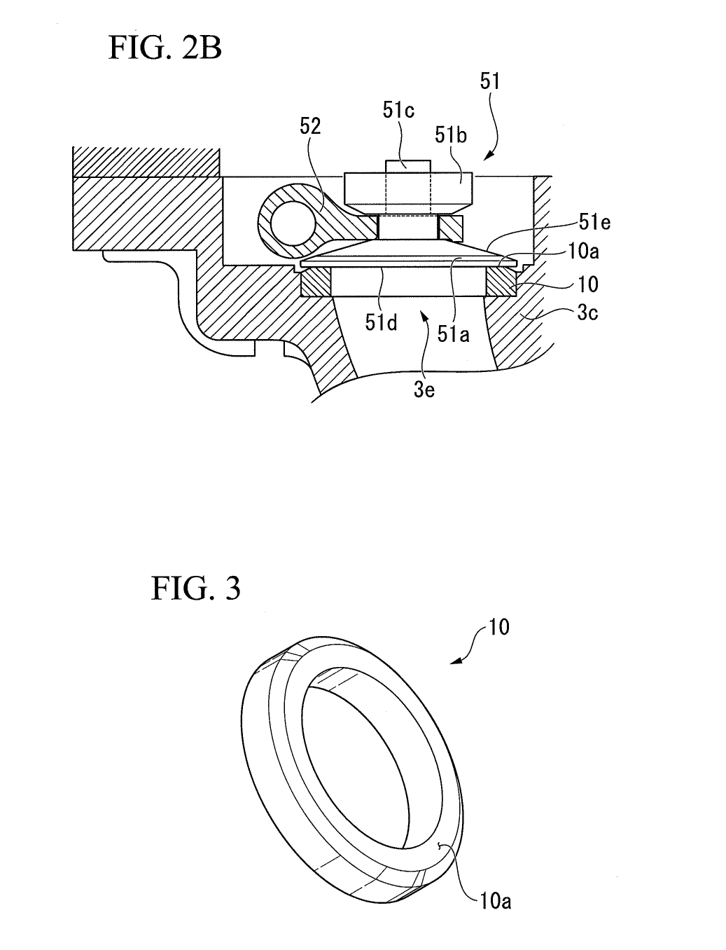

The low-pressure stage compressor 2a is provided with a compressor impeller that is not illustrated and a compressor housing not illustrated that surrounds this compressor impeller and in which an air flow passage is formed. Also, the low-pressure stage turbine 2b is provided with a turbine impellor 2d and a turbine housing 2c that surrounds the turbine impeller 2d and in which an exhaust gas flow passage is formed (refer to FIG. 2A). The compressor impeller and the turbine impeller 2d are coupled by a shaft, and compressed air is generated by the compressor impeller being rotatively driven by the turbine impeller 2d being rotatively driven by the exhaust gas.

The high-pressure stage turbocharger 3 is arranged more to the upstream than the low-pressure stage turbocharger 2 in the flow direction of the exhaust gas.

This high-pressure stage turbocharger 3 is provided with a high-pressure stage compressor 3a and a high-pressure stage turbine 3b.

The high-pressure stage compressor 3a is provided with a compressor impeller that is not illustrated, and a compressor housing not illustrated that surrounds this compressor impeller and in which an air flow passage is formed.

Also, the high-pressure stage turbine 3b is provided with a turbine impeller that is not illustrated, and a turbine housing 3c that surrounds this turbine impeller and in which an exhaust gas flow passage is formed (housing of the high-pressure stage turbocharger 3 (second turbocharger 2)) (refer to FIG. 2A).

The compressor impeller and the turbine impeller are coupled by a shaft, and compressed air is generated by the compressor impeller being rotatively driven by the turbine impeller being rotatively driven by the exhaust gas.

Note that as shown in FIG. 2A, the turbine housing 2c of the low-pressure stage turbine 2b and the turbine housing 3c of the high-pressure stage turbine 3d are joined by their flanges being butt-joined.

Inside of the turbine housing 3c of the high-pressure stage turbine 3b, an exhaust flow passage 3d that discharges exhaust gas that has passed through the turbine impeller of the high-pressure stage turbine 3b and a bypass flow passage 3e for supplying exhaust gas to the low-pressure stage turbine 2b without involving this turbine impeller are provided.

Also, a supply flow passage 2e for supplying exhaust gas to the turbine impeller 2d of the low-pressure stage turbine 2b is provided in the interior of the turbine housing 2c of the low-pressure stage turbine 2b.

By the joining of the turbine housing 2c of the low-pressure stage turbine 2b and the turbine housing 3c of the high-pressure stage turbine 3b, the exhaust flow passage 3d, the bypass flow passage 3e and the supply flow passage 2e are connected.

Returning to FIG. 1, the check valve 4 is provided in the bypass flow passage that supplies the compressed air that has been discharged from the low-pressure stage compressor 2a of the low-pressure stage turbocharger 2 to the air intake side of the engine 101 without involving the high-pressure stage compressor 3a, in the case of the high-pressure stage compressor 3a of the high-pressure stage turbocharger 3 not being driven. As shown in FIG. 1, the check valve 4 is constituted to allow the flow of compressed air from the low-pressure stage compressor 2a to the engine 101, and prevent the reverse flow of compressed air from the engine 101 to the low-pressure stage compressor 2a.

The exhaust bypass valve device 5 performs opening and closing of the bypass flow passage 3e for supplying exhaust gas that has been discharged from the engine 101 to the low-pressure stage turbocharger 2, bypassing the turbine impeller of the high-pressure stage turbocharger 3.

The exhaust bypass valve device 5 is provided with a valve assembly 51, a mounting plate 52, and an actuator 53, as shown in FIG. 2A and FIG. 2B.

FIG. 2B is an enlarged view that includes the valve assembly 51 and the mounting plate 52.

As shown in this drawing, the valve assembly 51 has a constitution in which a valve body 51a that opens and closes the opening of the bypass flow passage 3e and a washer 51b that fixes this valve body 51a to the mounting plate 52 are coupled via a shaft portion 51c.

As shown in FIG. 2A, this valve assembly 51 is made rotatable so as to open and close the opening of the bypass flow passage 3e, at the boundary region of the turbine housing 2c of the low-pressure stage turbine 2b and the turbine housing 3c of the high-pressure stage turbine 3b.

A bottom surface 51d (the surface on the side that contacts the bypass flow passage 3e opening during closure) of the valve body 51a is made to be a flat surface, while the upper surface 51e thereof is made to be a tapered surface that descends from the center to the edge.

Also, in the present embodiment, a through hole is provided in the center of the washer 51b, and by the shaft portion 51c being passed through the through hole of the washer 51b from the upper portion of the valve body 51a, the distal end of the shaft portion 51c is disposed to project out from the washer 51b.

Due to the distal end of the shaft portion 51c and the washer 51b being for example joint-welded, the shaft portion 51c and the washer 51b are fixed.

The mounting plate 52 has a through hole through which the shaft portion 51c is inserted, and the shaft portion 51c is inserted in this through hole, whereby it is sandwiched by the valve body 51a and the washer 51b.

The mounting plate 52 is rotated as shown by the chain double-dashed line in FIG. 2A by the drive force from the actuator 53 being transmitted via a link plate assembly that is not illustrated. The valve assembly 51 is also rotated by the rotation of this mounting plate 52.

Also, in the two-stage turbocharging system 1 of the present embodiment, as shown in FIG. 2A, FIG. 2B, and FIG. 3, a ring member 10 is arranged in the turbine housing 3c of the high-pressure stage turbine 3b.

While the turbine housing 3c of the high-pressure stage turbine 3b is formed with cast iron, the ring member 10 is formed with austenitic stainless steel, whereby it has a higher oxidation resistance than the turbine housing 3c.

The ring member 10 is fixed by being press-fitted into the turbine housing 3c to constitute the end portion of the bypass flow passage 3e.

A portion of the surface of this ring member 10 on the valve body 51a side serves as a seal surface 10a that is abutted with the bottom surface 51d of this valve body 51a. In greater detail, at the surface of the ring member 10 on the valve body 51a side, the inner circumferential side region projects further out toward the valve body 51a side than the outer circumferential side region. This inner circumferential side region serves as the region that abuts the bottom surface 51d of the valve body 51a as the seal surface 10a.

The outer edge shape of the ring member 10 has approximately the same circular shape as the outer edge shape of the valve body 51a. Since the seal surface 10a serves as the inner circumferential side region of the surface of the ring member 10 on the valve body 51a side, in the present embodiment, the outer diameter of the seal surface 10a is smaller than the outer diameter of the bottom surface 51d of the valve body 51a.

Returning to FIG. 1, the waste gate valve 6 serves as a bypass for a portion of the exhaust gas that is discharged from the high-pressure stage turbocharger 3 or the exhaust gas that is discharged via the bypass flow passage 3e, without going through the turbine impeller 2d of the low-pressure stage turbocharger 2, and its opening degree is adjusted by the ECU 105 or the turbocharging pressure of the low-pressure stage compressor 2a.

In the two-stage turbocharging system 1 of the present embodiment that has this kind of constitution, the ring member 10 that is formed with austenitic stainless steel is press-fitted in the turbine housing 3c, and the end portion of the bypass flow passage 3e is formed by this ring member 10. Since this ring member 10 has the seal surface 10a, in the present embodiment, the seal surface 10a has a higher oxidation resistance than the turbine housing 3c.

Accordingly, in the two-stage turbocharging system 1 of the present embodiment, it is possible to inhibit oxidation of a portion or the entirety of the seal surface 10a of the opening of the bypass flow passage 3e.

As a result, a large difference in the thermal expansion coefficient does not arise at the seal surface 10a, and so it is possible to prevent exfoliation at the seal surface 10a.

Also, in the two-stage turbocharging system 1 of the present embodiment, using the ring member 10 that consists of austenitic stainless steel raises the oxidation resistance of the seal surface 10a. For this reason, it is possible to prevent exfoliation at the seal surface 10a with a simple constitution.

Also, in the two-stage turbocharging system 1 of the present embodiment, the outer diameter of the seal surface 10a is smaller than the outer diameter of the bottom surface 51d of the valve body 51a.

For this reason, compared with the case of the outer diameter of the seal surface 10a being the same as or larger than the outer diameter of the bottom surface 51d of the valve body 51a, it is possible to reduce the contact region of the bottom surface 51d of the valve body 51a and the seal surface 10a, and raise the surface pressure at the seal surface 10a during closure of the bypass flow passage 3e.

Accordingly, according to the two-stage turbocharging system 1 of the present embodiment, it is possible to further raise the seal performance during closure of the bypass flow passage 3e. Moreover, by adjusting the size of the seal surface, it is possible to adjust the seal surface pressure.

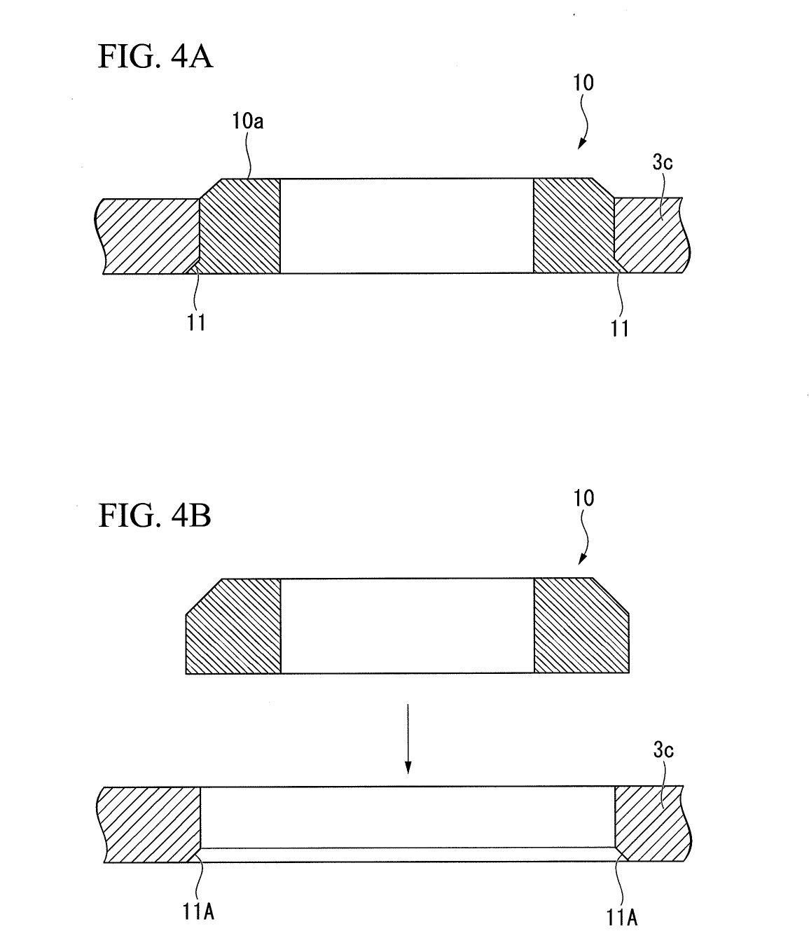

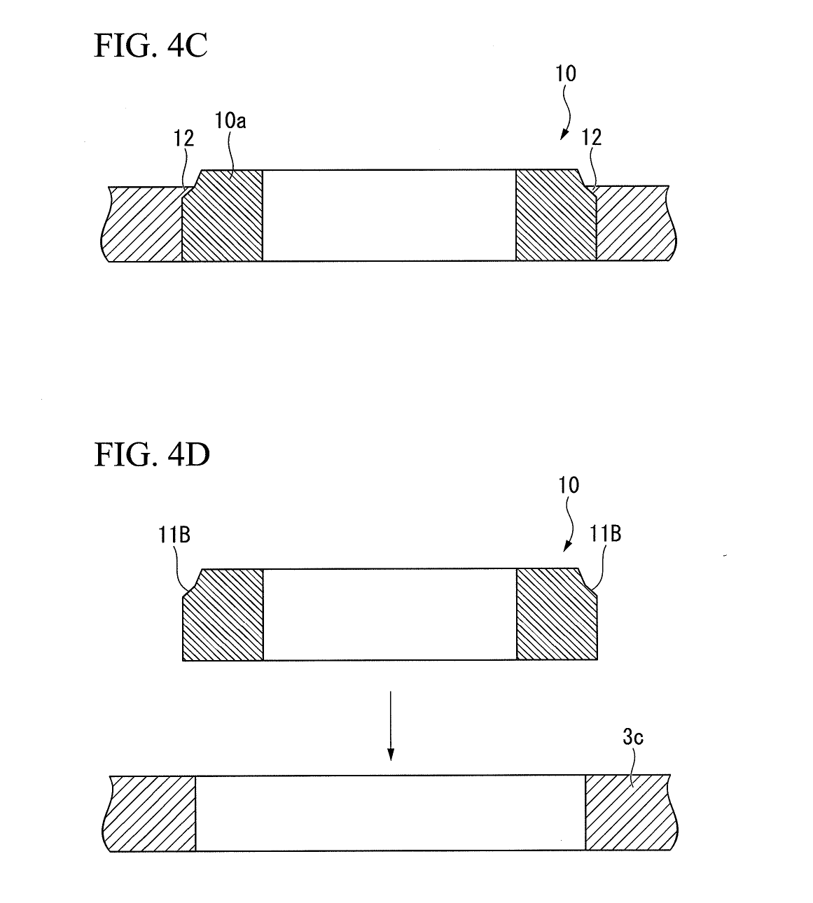

Note that in the two-stage turbocharging system 1 of the present embodiment, as shown in FIG. 4A, a protruding portion 11 that protrudes toward the turbine housing 3c may be provided on the ring member 10.

By providing this kind of protruding portion 11, movement of the ring member 10 in the direction opposite to the direction when press-fitting the ring member 10 with respect to the turbine housing 3c is restricted, and so it is possible to prevent the ring member 10 from coming out.

That is to say, in the constitution that is shown in FIG. 4A, the protruding portion 11 that is provided on the ring member 10 functions as a retaining mechanism of the present invention.

The protruding portion 11 shall be described in detail. As stated above, the ring member 10 is press-fitted into the turbine housing 3c.

For this reason, when the ring member 10 is press-fitted into the turbine housing 3c, the ring member 10 elastically contracts toward the inner side in the radial direction of the ring member 10 due to the turbine housing 3c. On the other hand, the turbine housing 3c elastically expands to the outer side in the radial direction of the turbine housing 3c due to the ring member 10.

Here, as shown in FIG. 4B, in the case of a notch 11A being formed at the distal end of the inner periphery surface of the turbine housing 3c in the press-fitting direction of the ring member 10 (refer to the arrow in FIG. 4B), at the location of the notch 11A, the turbine housing 3c that acts so as to cause the ring member 10 to contract toward the inner side in the radial direction of the ring member 10 does not exist. Therefore, at the location of the notch 11A, the ring member 10 is partially released from the elastic contraction. Accordingly, the portion of the ring member 10 at the location that is partially released from the elastic contraction becomes the protruding portion 11.

Also, in the two-stage turbocharging system 1 of the present embodiment, as shown in FIG. 4C, a protruding portion 12 that protrudes toward the ring member 10 may be provided at the turbine housing 3c.

By providing this kind of protruding portion 12, movement of the ring member 10 in the direction opposite to the direction when pressing the ring member 10 with respect to the turbine housing 3c is restricted, and so it is possible to prevent the ring member 10 from coming out.

That is to say, in the constitution shown in FIG. 4C, the protruding portion 12 that is provided at the turbine housing 3c functions as a retaining mechanism of the present invention.

The protruding portion 12 shall be described in detail. In this case as well, the ring member 10 that has been press-fitted into the turbine housing 3c elastically contracts toward the inner side in the radial direction of the ring member 10 due to the turbine housing 3c. On the other hand, the turbine housing 3c elastically expands to the outer side in the radial direction of the turbine housing 3c due to the ring member 10.

Here, as shown in FIG. 4D, in the case of a notch 11B being formed in the outer periphery surface of the ring member 10 in the vicinity of the rear end in the press-fitting direction (refer to the arrow of FIG. 4D), at the location of the notch 11B, the ring member 10 that is pressed into the turbine housing 3c, and that acts so as to cause the turbine housing 3c to elastically expand to the outer side in the radial direction of the turbine housing 3c does not exist. Therefore, at the location of the notch 11B, the turbine housing 3c is partially released from the elastic contraction. Accordingly, the portion of the turbine housing 3c at the location that is partially released from the elastic expansion becomes the protruding portion 12.

Hereinabove, preferred embodiments of the present invention were described with reference to the appended drawings, but the present invention is not to be limited to the embodiments. The various shapes and combinations of each composite member shown in the embodiment described above refer to only a single example, and may be altered in various ways based on design requirements and so forth within a scope that does not deviate from the subject matter of the present invention.

Also, in the embodiment, the constitution was described of raising the oxidation resistance of the seal surface 10a by press-fitting and fixing the ring member 10 that is formed with austenitic stainless steel into the turbine housing 3c.

However, the present invention is not limited to this, and for example, it is also possible to adopt a constitution that makes a portion of the surface of the turbine housing 3c serve as the seal surface without using the ring member 10, and raises the oxidation resistance of the seal surface by performing an oxidation prevention surface treatment such as a fluorine coating on this seal surface.

Also, in the present embodiment, the constitution was described of fixing the ring member 10 by press-fitting it into the turbine housing 3c.

However, the present invention is not limited to this, and it is also possible to adopt a constitution that fixes the ring member 10 by casting it in a mold when forming the turbine housing 3c.

Also, in the embodiment, a constitution provided with two turbochargers was described.

However, the present invention is not limited to this, and moreover it is possible to adopt a constitution that is provided with a still greater plurality of turbochargers.

Also, in the aforementioned example, the example was given of the protruding portion 11 being provided at the distal end of the outer periphery surface of the ring member 10 in the press-fitting direction, and the protruding portion 12 being provided at the rear end of inner periphery surface of the turbine housing 3c with respect to the press-fitting direction of the ring member 10, but it is not limited to these examples. That is to say, the notch portion 11A may be provided at the inner periphery surface of the turbine housing 3c so that the protruding portion 11 is provided at any location of the outer periphery surface of the ring member 10. Similarly, the notch 11B may be provided at the outer periphery surface of the ring member 10 so that the protruding portion 12 is provided at any location of the inner periphery surface of the turbine housing 3c. Also, a plurality of the notches 11A may be provided in the height direction on the inner periphery surface of the turbine housing 3c, so that a plurality of the protruding portions 11 are provided in the height direction on the outer periphery surface of the ring member 10. Similarly, a plurality of the notches 11B may be provided in the height direction on the outer periphery surface of the ring member 10 so that a plurality of the protruding portions 12 are provided in the height direction on the inner periphery surface of the turbine housing 3c.

### INDUSTRIAL APPLICABILITY

In the multistage turbocharging system, since the seal surface of the opening of the bypass flow passage has a higher oxidation resistance than the housing of the second turbocharger, it is possible to inhibit oxidation of a portion or the entirety of the seal surface of the opening of the bypass flow passage.

As a result, at the seal surface, it is possible to prevent exfoliation at the seal surface, without causing a large difference in the thermal expansion coefficient.

### DESCRIPTION OF REFERENCE NUMERALS

1 two-stage turbocharging system (multistage turbocharging system)
2 low-pressure stage turbocharger (first turbocharger)
2c turbine housing
2d turbine impeller
3 high-pressure stage turbocharger (second turbocharger)
3c turbine housing
3e bypass flow passage
5 exhaust bypass valve device
10 ring member
10a seal surface
11 protruding portion (retaining mechanism)
12 protruding portion (retaining mechanism)
51 valve assembly
51a valve body
51b washer
51c shaft portion
51d bottom surface
51e upper surface
52 mounting plate
101 engine (internal combustion engine)

1. A multistage turbocharging system comprising:
a first turbocharger that is supplied with exhaust gas that is discharged from an internal combustion engine;
a second turbocharger that is arranged more on the upstream in the flow of the exhaust gas than the first turbocharger; and
an exhaust bypass valve device that performs opening and closing of a bypass flow passage that supplies the exhaust gas that is discharged from the internal combustion engine to the first turbocharger by bypassing the turbine impeller of the second turbocharger,
wherein a seal surface of the opening of the bypass flow passage that is abutted by the bottom surface of a valve body of the exhaust bypass valve device has a higher oxidation resistance than the housing of the second turbocharger.

2. The multistage turbocharging system according to claim 1, wherein the seal surface is formed by a ring member that is formed with austenitic stainless steel.

3. The multistage turbocharging system according to claim 2, wherein
the ring member is fixed by being press-fitted into the housing of the second turbocharger, and has a retaining mechanism that restricts movement in the direction opposite to the direction of press-fitting the ring member with respect to the housing of the second turbocharger.

4. The multistage turbocharging system according to claim 2, wherein the seal surface is set to an annular shape having an outer diameter smaller than the outer diameter of the bottom surface of the valve body.

5. The multistage turbocharging system according to claim 3, wherein the seal surface is set to an annular shape having an outer diameter smaller than the outer diameter of the bottom surface of the valve body.

6. The multistage turbocharging system according to claim 3, wherein the retaining mechanism is a protruding portion that is one portion of the ring member that has been press-fitted into the housing of the second turbocharger, and that has been partially released from the elastic compression by the housing of the second turbocharger.

7. The multistage turbocharging system according to claim 3, wherein the retaining mechanism is a protruding portion that is one portion of the housing of the second turbocharger into which the ring member has been press-fitted, and that has been partially released from the elastic expansion by the ring member.
